(19) United States
(12) Patent Application Publication
(10) Pub. No.: US 2022/0367854 A1
(43) Pub. Date: Nov. 17, 2022

(54) ANODE INCLUDING A PHOSPHORUS-DOPED GRAPHITIC CARBON NITRIDE INTERPHASE LAYER FOR A RECHARGEABLE BATTERY, A LITHIUM RECHARGEABLE BATTERY HAVING SAME, AND A METHOD OF MANUFACTURING SAME

(71) Applicants: HYUNDAI MOTOR COMPANY, Seoul (KR); KIA CORPORATION, Seoul (KR); KOREA ADVANCED INSTITUTE OF SCIENCE AND TECHNOLOGY, Daejeon (KR)

(72) Inventors: Jong Chan Song, Suwon-si (KR); Jae Wook Shin, Seoul (KR); Ji Yong Lee, Seongnam-si (KR); Seong Min Ha, Seoul (KR); Hee Tak Kim, Daejeon (KR); Young Il Roh, Daejeon (KR)

(73) Assignees: HYUNDAI MOTOR COMPANY, Seoul (KR); KIA CORPORATION, Seoul (KR); KOREA ADVANCED INSTITUTE OF SCIENCE AND TECHNOLOGY, Daejeon (KR)

(21) Appl. No.: 17/535,288

(22) Filed: Nov. 24, 2021

(30) Foreign Application Priority Data
May 6, 2021 (KR) 10-2021-0058425

(51) Int. Cl. H01M 4/36; H01M 4/40; H01M 4/58

(52) U.S. Cl. CPC H01M 4/366; H01M 4/405; H01M 4/58; H01M 2004/027

(57) ABSTRACT

An anode for a lithium rechargeable battery includes an interphase layer made of phosphorus-doped graphitic carbon nitride. The anode includes a lithium metal layer and an interphase layer provided on the lithium metal layer, in which the interphase layer includes phosphorus-doped graphitic carbon nitride. The interphase layer induces the lithium growth in a plane direction and reduces the growth of dendrites and decomposition of an electrolyte.

### CROSS REFERENCE TO RELATED APPLICATION

The present application claims priority to Korean Patent Application No. 10-2021-0058425, filed May 6, 2021, the entire contents of which is incorporated herein for all purposes by this reference.

### BACKGROUND

### Technical Field

The present disclosure relates to an anode for a lithium rechargeable battery, the anode including an interphase layer made of phosphorus-doped graphitic carbon nitride, thereby inducing the lithium growth in a plane direction, and reducing the growth of dendrites and decomposition of an electrolyte.

### Description of the Related Art

Batteries with lithium-metal anodes have been spotlighted as the next-generation lithium rechargeable batteries having high capacity and high energy density. Examples of such batteries may include a lithium-metal battery, a lithium-sulfur battery, and a lithium air-battery.

Because lithium metal used as an anode has a low density (0.54 g·cm⁻³) and a low standard reduction potential (−3.040 V based on the standard hydrogen electrode (SHE)), it is possible to realize a high theoretical capacity (3860 mAh/g) and a high energy density per volume or per weight. However, a lithium metal battery has serious problems such as formation of lithium dendrites and low Coulombic efficiency.

During the electrochemical cycles of a battery, dendritic lithium (lithium dendrite) and dead lithium are formed at the lithium metal anode, causing loss of active materials. In addition, lithium metal, which is highly reactive, forms a solid electrolyte interphase (SEI) layer on the surface through reactions with an electrolyte and residual water. Then, the SEI layer is repeatedly broken and formed again due to an increase in the surface area of the electrode caused by formation of dendrites and dead lithium. Therefore, the lithium metal and the electrolyte are continuously consumed, which results in low Coulombic efficiency of the lithium metal anode and short cycle life.

In addition, if lithium dendrites grow and puncture a separator, an internal short-circuit may occur, leading to safety problems such as fire accidents, explosion, or the like. Therefore, a strategy is required that inhibits the growth of lithium dendrites and induces uniform lithium growth in order to implement a high-performance and high-safety lithium metal battery.

### SUMMARY

An objective of the present disclosure is to provide a lithium rechargeable battery anode having an interphase layer, wherein the anode induces uniform nucleation of lithium and inducing lithium to grow in a plane direction when charging battery.

Another objective of the present disclosure is to provide a lithium rechargeable battery anode having an interphase layer, wherein the anode suppresses the growth of dendrites and consumption of an electrolyte.

Objectives of the present disclosure are not limited to the objectives described above. These and other objectives of the present disclosure may be understood from the following detailed description and become more fully apparent from the embodiments of the present disclosure. Also, the objectives of the present disclosure may be realized by the means shown in the appended claims and combinations thereof.

In order to achieve the above objective, according to one aspect, a lithium rechargeable battery anode is provided. The anode includes a lithium metal layer and an interphase layer provided on the lithium metal layer, wherein the interphase layer includes phosphorus-doped graphitic carbon nitride.

The interphase layer may be 10 nanometers (nm) to 5 micrometers (μm) thick.

The phosphorus-doped graphitic carbon nitride may have a peak intensity ratio I₀₀₂/I₁₀₀ in a range of 7 to 8, wherein the peak intensity ratio is a ratio of a peak for a crystal plane (002) and a peak for a crystal plane (100) obtained in an X-ray diffraction (XRD) spectrum.

The phosphorus-doped graphitic carbon nitride may have P═N peak and P—N peak observed in P₂ₚ X-ray photoelectron spectroscopy (XPS).

The phosphorus-doped graphitic carbon may have a concentration of phosphorus (P) in a range of 1 at. % to 2 at. %.

The interphase layer may include at least one binder selected from the group consisting of polyacrylic acid (PAA), polyvinylidene fluoride (PVDF), poly(vinylidene fluoride-co-hexafluoropropylene) (PVDF-HFP), and a combination thereof.

A mass ratio of the phosphorus-doped graphitic carbon nitride and the binder may be in a range of 9:1 to 5:5.

In order to achieve the above objective, according to one aspect, a lithium rechargeable battery is provided. The battery includes a cathode, the anode, a separator disposed between the cathode and the anode, and an electrolyte with which the separator is impregnated, wherein the interphase layer is disposed between the separator and the anode.

In order to achieve the above objective, according to one aspect, a method of manufacturing a lithium rechargeable battery is provided. The method includes: preparing a starting material including a carbon nitride precursor compound and a phosphorus precursor compound; reacting the starting material to prepare phosphorus-doped graphite carbon nitride; preparing a solution containing the phosphorus-doped graphitic carbon nitride and a binder; applying the solution to a first surface of a separator to form an interphase layer; configuring an electrode assembly in which the first surface of the separator where the interphase layer is formed faces with a lithium metal layer to form an anode and a second surface of the separator faces with a cathode; and injecting an electrolyte into the electrode assembly.

The starting material may include 70 wt. % to 85 wt. % of the carbon nitride precursor compound and 15 wt. % to 30 wt. % of the phosphorus precursor compound.

The carbon nitride precursor compound may include at least one compound selected from the group consisting of melamine, dicyanamide, urea, and a combination thereof.

The phosphorus precursor compound may include at least one compound selected from the group consisting of hexachlorotriphosphazene, aminoethylphosphonic acid, phosphoric acid, and a combination thereof.

The starting material may be reacted at a temperature in a range of 400° C. to 700° C. for 2 hours to 6 hours in an inert atmosphere.

The interphase layer may be formed by applying the solution to the first surface of the separator and applying a vacuum to the second surface of the separator to vacuum-filter the solution.

When charging a battery, uniform nucleation of lithium occurs, and lithium grows in a plane direction rather than a thickness direction so that it is possible to suppress the growth of dendrites and consumption of an electrolyte effectively.

It is possible to obtain a lithium rechargeable battery with an improved cycle life.

Effects of the present disclosure are not limited to the effects described above. Effects of the present disclosure are not limited to the effects described above, and the present disclosure includes all effects that can be deduced from the detailed description.

### BRIEF DESCRIPTION OF THE DRAWINGS

The above and other objectives, features, and other advantages of the present disclosure should be more clearly understood from the following detailed description when taken in conjunction with the accompanying drawings, in which:

FIG. 1 is a schematic view illustrating an example of a lithium rechargeable battery;

FIG. 2 illustrates a result of an X-ray diffraction analysis of Example 1, Example 2, Comparative Example 1, and Comparative Example 2;

FIG. 3A illustrates a result of an X-ray photoelectron spectroscopy (XPS) analysis of N₁ₛ of PCN30 according to Example 2;

FIG. 3B illustrates a result of an XPS analysis of P₂ₚ of PCN30 according to Example 2;

FIG. 4A illustrates a result of analyzing an interaction between CN and lithium ions in Experimental Example 1;

FIG. 4B illustrates a result of analyzing an interaction between PCN30 and lithium ions in Experimental Example 1;

FIG. 5 illustrates a result of measuring zeta potential of samples formed into films using CN, PCN15, PCN30 and PCN45 respectively in Experimental Example 1;

FIG. 6 illustrates a result of ⁷Li nuclear magnetic resonance (NMR) analysis of CN powders and PCN30 powders in Experimental Example 1;

FIG. 7A illustrates a result of scanning electron microscope (SEM) analysis of a surface of an interphase layer according to Preparation Example 1;

FIG. 7B illustrates a result of SEM analysis of a cross section of the interphase layer according to Preparation Example 1;

FIG. 8A illustrates a result of SEM analysis of a surface of an interphase layer according to Comparative Preparation Example 1;

FIG. 8B illustrates a result of SEM analysis of a cross section of the interphase layer according to Comparative Preparation Example 1;

FIG. 9A illustrates a result of SEM analysis of lithium morphology on a copper surface when 0.1 mAh/cm² of lithium was electrodeposited on a cell according to Comparative Preparation Example 2;

FIG. 9B illustrates a result of SEM analysis of lithium morphology on a copper surface when 0.1 mAh/cm² of lithium was electrodeposited on a cell according to Comparative Preparation Example 3;

FIG. 9C illustrates a result of SEM analysis of lithium morphology on a copper surface when 0.1 mAh/cm² of lithium was electrodeposited on a cell according to Preparation Example 2;

FIG. 9D illustrates a result of SEM analysis of lithium morphology on a copper surface when 1 mAh/cm² of lithium was electrodeposited on a cell according to Comparative Preparation Example 2;

FIG. 9E illustrates a result of SEM analysis of lithium morphology on a copper surface when 1 mAh/cm² of lithium was electrodeposited on a cell according to Comparative Preparation Example 3;

FIG. 9F illustrates a result of SEM analysis of lithium morphology on a copper surface when 1 mAh/cm² of lithium was electrodeposited on a cell according to Preparation Example 2;

FIG. 10 illustrates a result of driving each lithium symmetric cell in Experimental Example 4;

FIG. 11A illustrates a result of SEM analysis of a lithium surface of the lithium symmetric cell (bare);

FIG. 11B illustrates a result of SEM analysis of a lithium surface of the lithium symmetric cell (CN-PAA);

FIG. 11C illustrates a result of SEM analysis of a lithium surface of the lithium symmetric cell (PCN15-PAA);

FIG. 11D illustrates a result of SEM analysis of a lithium surface of the lithium symmetric cell (PCN30-PAA);

FIGS. 11E and 11F illustrate the results of SEM analysis of a lithium surface of the lithium symmetric cell (PCN45-PAA) in different scales;

FIG. 12A illustrates a result of SEM analysis of a surface of an interphase layer of the lithium symmetric cell (CN-PAA);

FIG. 12B illustrates a result of SEM analysis of a surface of an interphase layer of the lithium symmetric cell (PCN15-PAA);

FIG. 12C illustrates a result of SEM analysis of a surface of an interphase layer of the lithium symmetric cell (PCN30-PAA);

FIG. 12D illustrates a result of SEM analysis of a surface of an interphase layer of the lithium symmetric cell (PCN45-PAA); and

FIG. 13 illustrates a result of driving each lithium symmetric cell in Experimental Example 6.

### DETAILED DESCRIPTION

The above and other objectives, features, and advantages of the present disclosure should be more clearly understood from the embodiments below when taken in conjunction with the accompanying drawings. However, the present disclosure is not limited to the embodiments described herein and may be embodied in other forms. The embodiments are presented to make complete disclosure of the present disclosure and help those who are ordinarily skilled in the art best understand the disclosure. The scope of the disclosure is defined only by the claims.

Like reference numerals are used throughout the different drawings to designate like elements. In these drawings, the shapes and sizes of members may be exaggerated for explicit and convenient description. Although the terms first, second, etc. may be used herein to describe various elements, these elements should not be limited by these terms. These terms are only used to distinguish one element from another element. For instance, a first element discussed below could be termed a second element without departing from the teachings of the present disclosure. Similarly, the second element could also be termed the first element. As used herein, the singular forms “a”, “an”, and “the” are intended to include the plural forms as well, unless the context clearly indicates otherwise.

The terms “comprise”, “include”, “have”, etc., when used in this specification, specify the presence of stated features, integers, steps, operations, elements, components, and/or combinations of them but do not preclude the presence or addition of one or more other features, integers, steps, operations, elements, components, and/or combinations thereof. In addition, when a layer, a film, a region, or a plate is referred to as being “on” or “under” another layer, another film, another region, or another plate, it can be “directly” or “indirectly” on the other layer, film, region, plate, or one or more intervening layers may also be present.

Unless otherwise indicated, all numbers, values and/or expressions referring to quantities of ingredients, reaction conditions, polymer compositions, and formulations used herein are to be understood as modified in all instances by the term “about” as such numbers are inherently approximations that are reflective of, among other things, the various uncertainties of measurement encountered in obtaining such values. Further, where a numerical range is disclosed herein, such a range is continuous, and includes every value from the minimum value to and including the maximum value of such range unless otherwise indicated. Still further, where such a range refers to integers every integer from the minimum value to and including the maximum value is included unless otherwise indicated.

FIG. 1 is a schematic view illustrating a lithium rechargeable battery. Referring to this, the lithium rechargeable battery includes: a cathode 10, an anode 20, a separator 30 disposed between the cathode 10 and the anode 20, and an electrolyte (not shown) with which the separator 30 is impregnated.

Hereinafter, a configuration of the lithium rechargeable battery is described in detail below.

### Cathode

The cathode 10 may include a cathode active material, a binder, a conductive agent, or the like.

The cathode active material may include at least one compound selected from the group consisting of lithium cobalt oxide, lithium nickel cobalt manganese oxide, lithium nickel cobalt aluminum oxide, lithium iron phosphate, lithium manganese oxide, and a combination thereof. However, the cathode active material is not limited thereto, and any cathode active material available in the art may be used.

The binder is a substance that aids the bonding of the cathode active material, the conductive agent, etc., and the bonding to a current collector. The binder may include polyvinylidene fluoride, polyvinyl alcohol, carboxymethylcellulose (CMC), starch, hydroxypropyl cellulose, regenerated cellulose, polyvinylpyrrolidone, tetrafluoroethylene, polyethylene, polypropylene, ethylene propylene diene terpolymer (EPDM), sulfonated EPDM, styrene-butadiene rubber, fluorine rubber, and other various copolymers.

The conductive agent is not particularly limited as long as the conductive agent has conductivity without causing adverse chemical changes in the battery. Examples of conductive agents may include: graphite such as natural graphite or synthetic graphite; a carbon-based material such as carbon black, acetylene black, ketjen black, channel black, furnace black, lamp black, and thermal black; a conductive fiber such as carbon fiber and metallic fiber; a metal powder such as carbon fluoride powder, aluminum powder, and nickel powder; conductive whisker such as zinc oxide and potassium titanate; conductive metal oxides such as titanium oxide; and a conductive material such as polyphenylene derivatives.

### Anode

The anode 20 may include a lithium metal layer 21 and an interphase layer 22 provided on the lithium metal layer 21.

The lithium metal layer 21 may include lithium metal or a lithium metal alloy.

The lithium metal alloy may include lithium and a metal or metalloid alloy capable of being alloyed with lithium.

The metal or metalloid capable of being alloyed with lithium may include Si, Sn, Al, Ge, Pb, Bi, Sb, or the like.

Lithium metal has a high electric capacity per unit weight, which is advantageous for realizing a high-capacity battery. However, lithium metal may cause a short circuit between the cathode 10 and the anode 20 due to the growth of dendrites during a process of deposition and dissolution of lithium ions. In addition, lithium metal has a high reactivity with the electrolyte, resulting in shorter life span of the battery due to side reactions therebetween. Meanwhile, because lithium metal has a large volume change during the charging and discharging process, lithium desorption may occur from the anode 20.

Accordingly, the present disclosure prevents occurrence of the above problem by placing the interphase layer 22 between the lithium metal layer 21 and the separator 30, the interphase layer 22 being capable of inducing lithium growth in the plane direction by strongly interacting with lithium ions.

In this description, “interaction” refers not only to the electrostatic attraction of phosphorus-doped graphitic carbon nitride and lithium element of the interphase layer 22, but also to that the phosphorus-doped graphitic carbon nitride and a lithium adatom electrodeposited on a surface of the lithium metal layer 21 form an orbital hybridization. This is described in more detail below.

In addition, in the present specification, the lithium growth in the “plane direction” means that lithium grows in the x-y plane based on a coordinate system of FIG. 1.

The interphase layer 22 may include phosphorus-doped graphite carbon nitride and a binder.

The present disclosure is characterized in that phosphorus-doped graphite carbon nitride is used as a constituent component of the interphase layer 22 instead of a general graphitic carbon nitride.

The phosphorus-doped graphite carbon nitride may be represented by Formula 1 below.

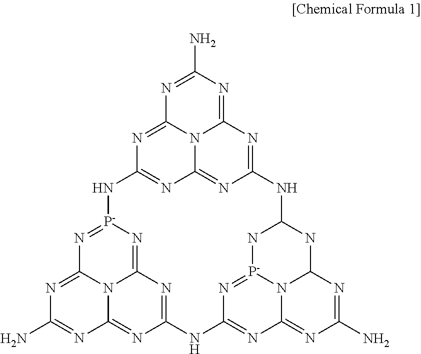 [SMILES: NC1=NC2=NC3=NC4=N[P-](=NC(=N1)N24)NC1=NC2=NC(=NC4=NC(N)=NC(=N1)N42)NC1NC2N=C(N)N=C4N=C(N=[P-](N1)N42)N3]

In this specification, “doping” means that a phosphorus element (P) is put into the chemical structure of graphitic carbon nitride and forms a compound, and specifically, means that a part of the carbon element (C) constituting the graphitic carbon nitride is substituted with phosphorus element (P).

The phosphorus-doped graphitic carbon nitride contains phosphorus having a lower electronegativity than that of carbon. Accordingly, in the phosphorus-doped graphitic carbon nitride, electrons are driven into nitrogen having a high electronegativity, and accordingly, energy of the electrons is further strengthened compared to general graphitic carbon nitride. Therefore, the interphase layer 22 is capable of having a stronger interaction with lithium ions.

In addition, because a phosphorus element in the phosphorus-doped graphitic carbon nitride has five valence electrons, a lone pair of electrons exists that remain after bonding with the surrounding nitrogen element. Accordingly, a lithium adatom, which passes through the interphase layer 22 and is electrodeposited on the surface of the lithium metal layer 21, and a lone pair of electrons of phosphorus element form an orbital hybridization and strongly interact with each other. Therefore, the adatom of lithium ion is to grow in a direction where the adatom can interact as much as possible with the phosphorus-doped graphitic carbon nitride of the interphase layer 22. In other words, in the anode, lithium tends to grow in the plane direction.

The binder may include at least one compound selected from the group consisting of polyacrylic acid (PAA), polyvinylidene fluoride (PVDF), poly(vinylidene fluoride-co-hexafluoropropylene) (PVDF-HFP), and a combination thereof.

The interphase layer 22 may include the phosphorus-doped graphite carbon nitride and a binder in a ratio of 9:1 to 5:5 by mass. If the mass ratio of the binder is less than 1, the interphase layer 22 may not be properly formed, and if the mass ratio of the binder exceeds 5, it may be difficult to implement the above-described effect.

The interphase layer 22 may be 10 nm to 5 μm thick. When the thickness of the interphase layer 22 is the same as above, the above-described effect can be implemented without interfering with the movement of lithium ions.

### Separator

The separator 30 is configured to prevent physical contact between the cathode 10 and the anode 20.

The separator 30 may include any, as long as being widely used in the technical field to which the present disclosure belongs, and may include, for example, polypropylene, polyethylene, or the like.

### Electrolyte

The electrolyte is responsible for the movement of lithium ions between the cathode 10 and the anode 20. The electrolyte may include a lithium salt, an organic solvent, an additive, or the like.

The electrolyte may be impregnated with the cathode 10 and the separator 30 entirely or partly.

The lithium salt is not particularly limited but may include lithium bis(trifluoromethanesulfonyl) imide (LiTFSI).

A concentration of the lithium salt is also not limited, but may be controlled within a range of 0.1 M to 5.0 M. In this range, the electrolyte can have an appropriate conductivity and viscosity, and lithium ions can effectively move within the lithium rechargeable battery of the embodiment. However, this is merely an example, and the present disclosure is not limited thereby.

The organic solvent may be a mixture of 1,3-dioxolane (DOL) and dimethoxy ethane (DME) in a ratio of 3:7 to 7:3 by volume, (e.g., 5:5 to 7:3).

The additive may include anything used in the technical field to which the present disclosure pertains, as long as it does not violate the desired effect of the present disclosure, and may include, for example, LiNO₃.

A method of manufacturing a lithium rechargeable battery includes: preparing a starting material including a carbon nitride precursor compound and a phosphorus precursor compound; reacting the starting material to prepare phosphorus-doped graphite carbon nitride; preparing a solution containing the phosphorus-doped graphitic carbon nitride and a binder; applying the solution to a first surface of a separator to form an interphase layer; configuring an electrode assembly in which the first surface of the separator where the interphase layer is formed faces with a lithium metal layer to form an anode and a second surface of the separator faces with a cathode; and injecting an electrolyte into the electrode assembly.

The carbon nitride precursor compound may include at least one compound selected from the group consisting of melamine, dicyanamide, urea, and a combination thereof.

The phosphorus precursor compound may include at least one compound selected from the group consisting of hexachlorotriphosphazene, aminoethylphosphonic acid, phosphoric acid, and a combination thereof.

The starting material may include 70 wt. % to 85 wt. % of the carbon nitride precursor compound and 15 wt. % to 30 wt. % of the phosphorus precursor compound. If the content of the phosphorus precursor compound exceeds 30 wt. %, the content of the phosphorus in the phosphorus-doped graphitic carbon nitride is too large, resulting in densification of the interphase layer.

The phosphorus-doped graphitic carbon nitride may be prepared by reacting the starting material at a temperature in a range of 400° C. to 700° C. for 2 hours to 6 hours in an inert atmosphere such as nitrogen gas atmosphere.

Thereafter, a solution containing the phosphorus-doped graphitic carbon nitride and the binder in a ratio of 9:1 to 5:5 by mass may be prepared, and the solution may be applied to a first surface of the separator to form the interphase layer.

The interphase layer may be formed by various methods. For example, in one method, after applying the solution to the first surface of the separator, a vacuum may be applied to the opposite side of the separator to vacuum-filter the solution in order to form the interphase layer. Through the vacuum filtration method, an extremely thin interphase layer of several hundred nanometers can be formed without cracking.

Thereafter, the anode is provided on the first surface of the separator on which the interphase layer is formed, and the cathode is provided on the second surface of the separator to prepare the electrode assembly. Then, the electrolyte is injected to the electrode assembly to manufacture the lithium rechargeable battery.

### EXAMPLES AND COMPARATIVE EXAMPLES

Hereinafter, the present disclosure is described in detail with reference to the following Examples and Comparative Examples. However, the concepts of the present disclosure are not limited or restricted thereto.

### Examples 1, Example 2, Comparative Example 1, and Comparative Example 2

Melamine and hexachlorotriphosphazene as starting materials were uniformly mixed in a mass ratio of 100:0 (Comparative Example 1), 85:15 (Example 1), 70:30 (Example 2) and 55:45 (Comparative Example 2), respectively. After uniformly mixed, heat treatment was performed at about 550° C. for about 4 hours. The obtained materials are hereinafter referred to as CN (Comparative Example 1), PCN15 (Example 1), PCN30 (Example 2), and PCN45 (Comparative Example 2), respectively. Specifically, CN is a general graphitic carbon nitride that is not doped with phosphorus, and PCN15, PCN30, and PCN45 are phosphorus-doped graphitic carbon nitrides, meaning that the content of the doped phosphorus increases as the number increases.

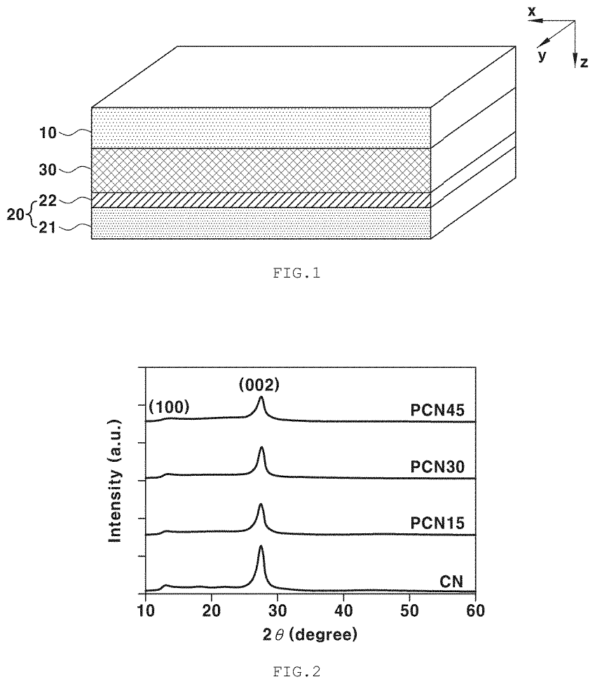

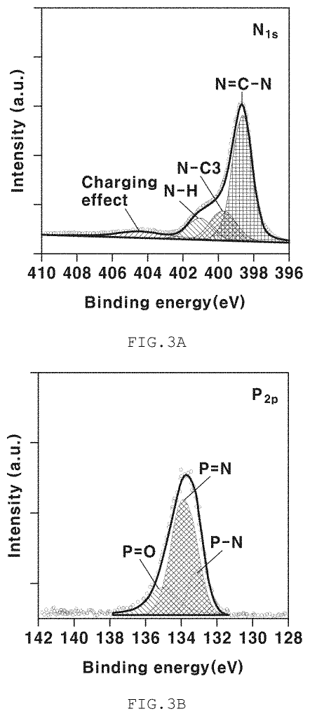

FIG. 2 illustrates a result of an X-ray diffraction analysis of Example 1, Example 2, Comparative Example 1, and Comparative Example 2. Referring to FIG. 2, CN, PCN15, PCN30, and PCN45 had all the same crystal structure in light of the point that CN, PCN15, PCN30, and PCN45 showed a peak for the crystal plane (100), which appeared near 20=13°, and a peak for the crystal plane (002), which appeared near 26=27°, in common.

Because the atomic radius of the phosphorus element is larger than that of carbon, distortion occurred in the crystal structures, and the peak sizes of PCN15, PCN30, and PCN45 were reduced. Specifically, the phosphorus-doped graphitic carbon nitrides of Examples 1 and 2 have a peak intensity ratio I₀₀₂/I₁₀₀ in a range of 7 to 8, wherein the peak intensity ratio is a ratio of the peak for the crystal plane (002) and the peak for the crystal plane (100) obtained in an X-ray diffraction (XRD) spectra. Hereinafter, the peak ratio of each sample is described in Table 1.

TABLE 1

| Category | CN | PCN15 | PCN30 | PCN45 |
|---|---|---|---|---|
| I₀₀₂/I₁₀₀ | 7.2 | 7.5 | 7.7 | 8.25 |

FIG. 3A illustrates a result of an X-ray photoelectron spectroscopy (XPS) analysis of N₁ₛ of PCN30 according to Example 2. FIG. 3B illustrates a result of an XPS analysis of P₂ₚ of PCN30 according to Example 2. Referring to FIGS. 3A and 3B, PCN30 had PN peak and the P═N peak while PCN30 kept having N═CN, N—C3, and NH peaks in the same way as CN. In other words, PCN30 had a structure in which phosphorus is doped at a carbon site.

In addition, energy dispersive X-ray spectroscopy (EDS) analysis was performed to phosphorus-doped graphitic carbon nitrides according to Examples 1, 2 and Comparative Example 2 to measure the concentration of nitrogen contained in each sample. The results are shown in Table 2 below. Referring to Table 2, the phosphorus-doped graphitic carbon nitrides of Examples 1 and 2 had a concentration of nitrogen in a range of 1 at. % to 2 at. %.

TABLE 2

| Category | PCN15 | PCN30 | PCN45 |
|---|---|---|---|
| Concentration | 1.05 at. % | 1.37 at. % | 2.4 at. % |
| of Nitrogen | | | |

### Experimental Example 1—Comparison of Interaction with Lithium Ions

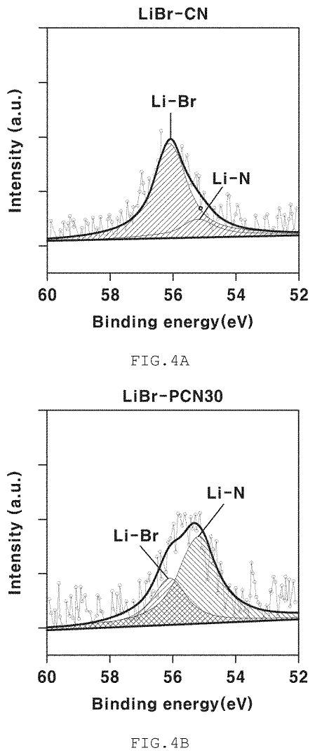

First, a film was formed using CN and PCN30, respectively, without adding a binder. Each film was immersed in 1M lithium bromide solution for a period of time, washed, and subjected to XPS analysis. FIG. 4A illustrates a result for CN; and FIG. 4B illustrates a result for PCN30. In both results, Li—Br peak and Li—N peak were observed, but much broader Li—N peak was observed in PCN30 compared with CN. In other words, the film containing PCN30 interacted more strongly with lithium ions.

Further, a film was formed using CN, PCN15, PCN30, and PCN45, respectively, without adding a binder. Each film was immersed to a solvent in which isopropyl alcohol and water were mixed in a ratio of 8:2 by volume, and the zeta potential was measured. The results are shown in FIG. 5. Referring to FIG. 5, a much stronger negative charge was observed as the doping amount of phosphorus increased compared to CN.

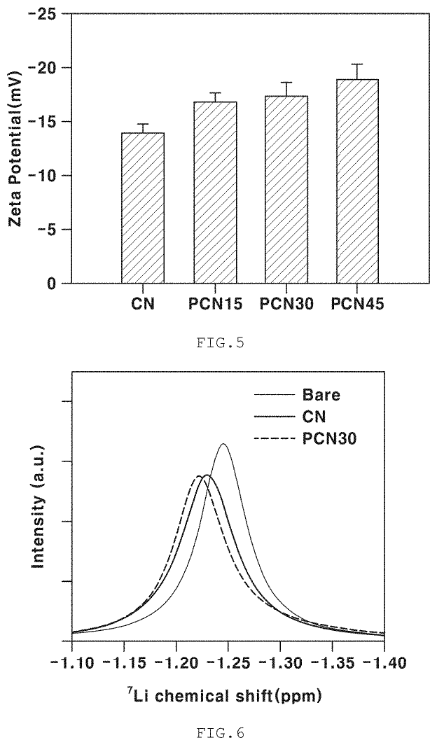

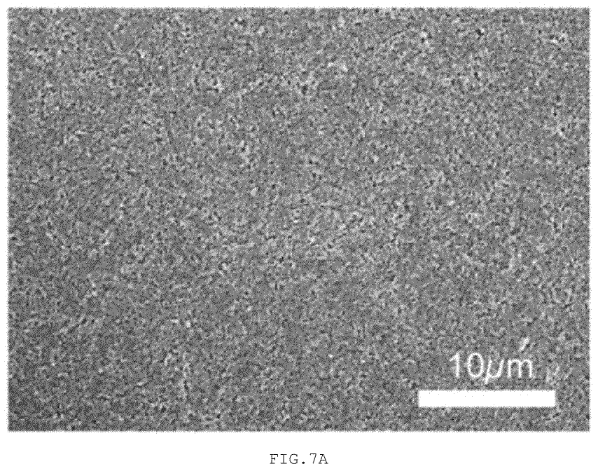

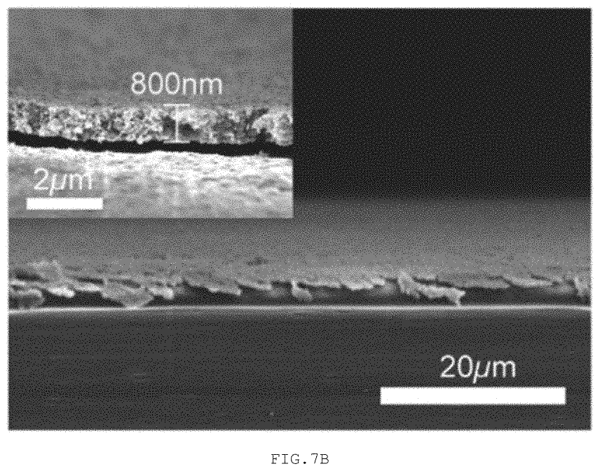

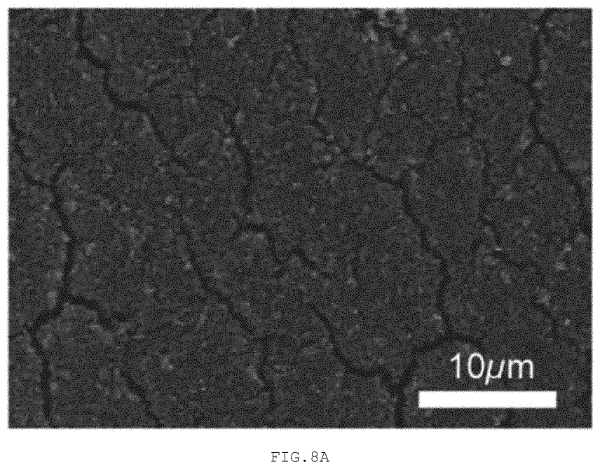

Meanwhile, 10 mg/ml of CN and PCN30 powders were dispersed in 1M LiTFSI DOL/DME electrolyte, respectively, and then ⁷Li NMR analysis was performed. The results are shown in FIG. 6. Referring FIG. 6, the peak shift of PCN30 is greater than that of CN. This is because PCN30 interacts more strongly with lithium due to its strong negative charge.

### Experimental Example 2—Preparation of Interphase Layer

(Preparation Example 1) An aqueous dispersion was prepared by dispersing PCN30 in a solvent in which isopropyl alcohol and water were mixed in a ratio of 8:2 by volume. In addition, an aqueous dispersion was prepared by dispersing polyacrylic acid (PAA) as a binder in the same solvent. The two prepared aqueous dispersion were mixed in a ratio where PCN30 and polyacrylic acid (PAA) was 5:5 by mass, and an interphase layer was formed on a substrate through vacuum filtration.

(Comparative Preparation Example 1) On the other hand, an interphase layer was formed in the same manner as Preparation Example 1 except that a binder was not used.

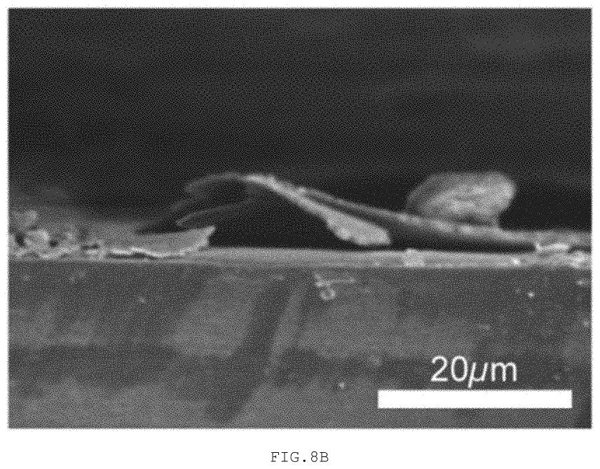

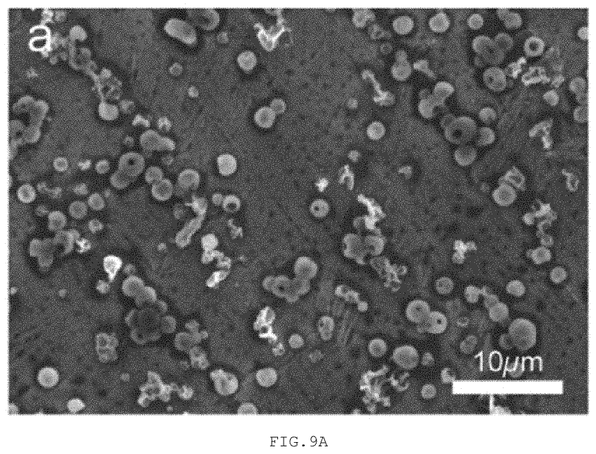

FIG. 7A illustrates a result of scanning electron microscope (SEM) analysis of a surface of the interphase layer according to Preparation Example 1. FIG. 7B illustrates a result of SEM analysis of a cross section of the interphase layer according to Preparation Example 1.

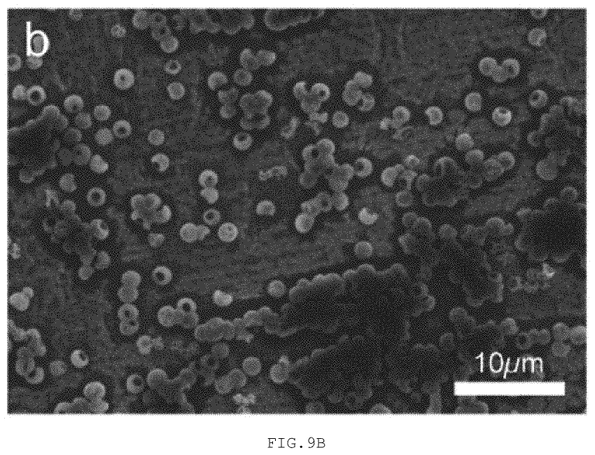

FIG. 8A illustrates a result of SEM analysis of a surface of the interphase layer according to Comparative Preparation Example 1. FIG. 8B illustrates a result of SEM analysis of a cross section of the interphase layer according to Comparative Preparation Example 1.

Referring to FIGS. 7A, 7B, 8A, and 8B, the interphase layer according to Preparation Example 1 is a nanometer-thick film that does not have cracks and is more uniform than that of Comparative Preparation Example 1.

### Experimental Example 3—Nucleation of Lithium and Growth Morphology Analysis

(Preparation Example 2) In the same manner as in Preparation Example 1 above, an interphase layer was formed on lithium metal, and a copper foil was attached to the interphase layer to assemble a Li/Cu cell, and then an electrolyte (1M LiTFSI DOL/DME+0.7 M LiNO₃) was injected therein.

(Comparative Preparation Example 2) A Li/Cu cell was prepared in the same manner as in Preparation Example 2 except that an interphase layer was not formed.

(Comparative Preparation Example 3) A Li/Cu cell was prepared in the same manner as in Preparation Example 2 except that CN was used instead of PNC30.

When each cell was electrodeposited with lithium of 0.1 mAh/cm² and 1 mAh/cm², respectively, under a condition of a current density of 0.2 mA/cm², lithium morphology of each copper surface was observed.

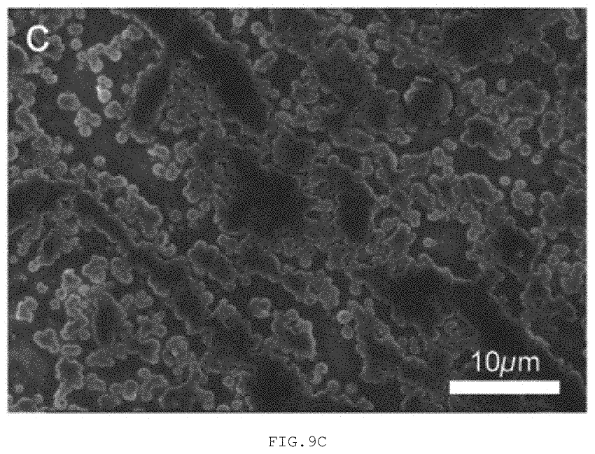

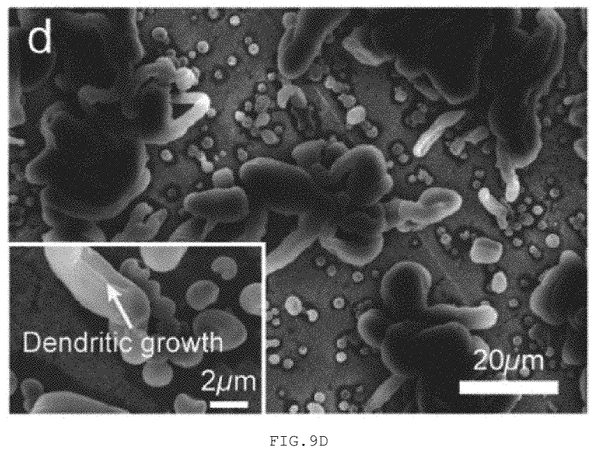

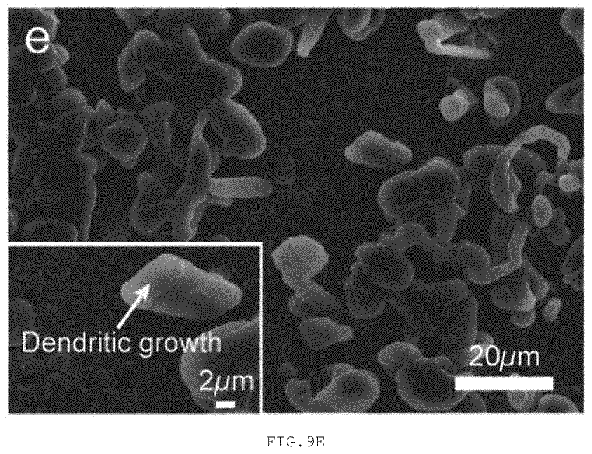

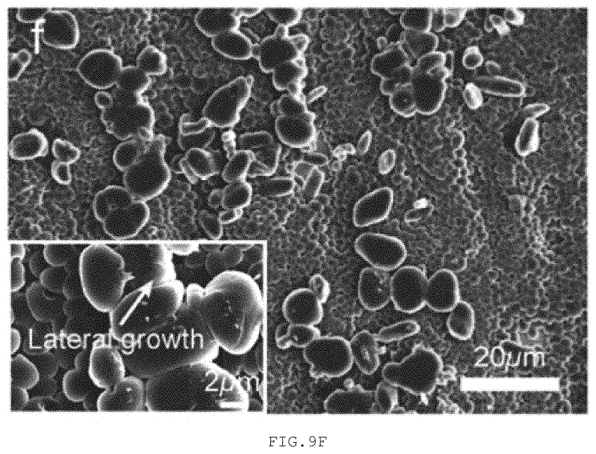

FIG. 9A illustrates a result of SEM analysis of lithium morphology on the copper surface when 0.1 mAh/cm² of lithium was electrodeposited on the cell according to Comparative Preparation Example 2. FIG. 9D illustrates a result of SEM analysis of lithium morphology on the copper surface when 1 mAh/cm² of lithium was electrodeposited on the cell according to Comparative Preparation Example.

FIG. 9B illustrates a result of SEM analysis of lithium morphology on the copper surface when 0.1 mAh/cm² of lithium was electrodeposited on the cell according to Comparative Preparation Example 3. FIG. 9E illustrates a result of SEM analysis of lithium morphology on the copper surface when 1 mAh/cm² of lithium was electrodeposited on the cell according to Comparative Preparation Example 3.

FIG. 9C illustrates a result of SEM analysis of lithium morphology on the copper surface when 0.1 mAh/cm² of lithium was electrodeposited on the cell according to Preparation Example 2. FIG. 9F illustrates a result of SEM analysis of lithium morphology on the copper surface when 1 mAh/cm² of lithium was electrodeposited on the cell according to Preparation Example 2.

When electrodepositing 0.1 mAh/cm² of lithium, occurrence of uniform nucleation of lithium was observed because lithium did not cover the entire copper surface. Referring to FIGS. 9A to 9C, the occurrence of more uniform nucleation of lithium was observed from the cells of Comparative Preparation Example 3 and Preparation Example 2 compared to Comparative Preparation Example 2.

However, when electrodepositing 1 mAh/cm² of lithium, a small number of lithium nuclei intensively grew in the cell of Comparative Preparation Example 2 and formed dendrites observed in FIG. 9D. In addition, referring to FIG. 9E, the uniform nucleation of lithium occurred in the cell of Comparative Preparation Example 3 at the beginning, but later when the nuclei grew further, several lithium nuclei grew intensively, and dendrites were observed as in Comparative Preparation Example 2. On the other hand, referring to FIG. 9F, in the cell according to Preparation Example 2, not only the uniform nucleation of lithium occurred at the beginning, but also the lithium grows in the plane direction thereafter.

### Experimental Example 4—Lithium Symmetric Cell Test

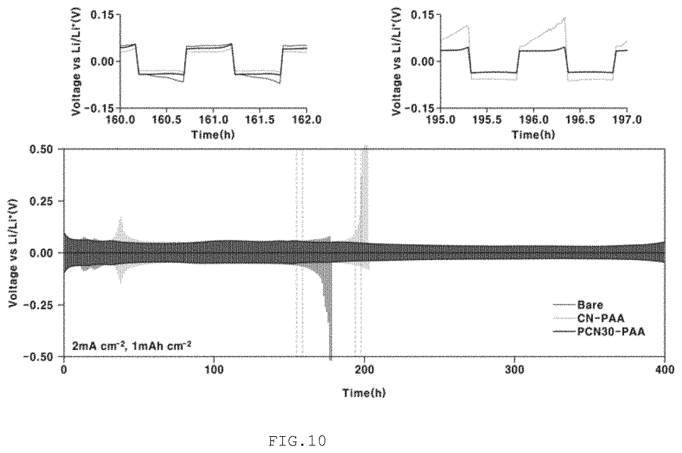

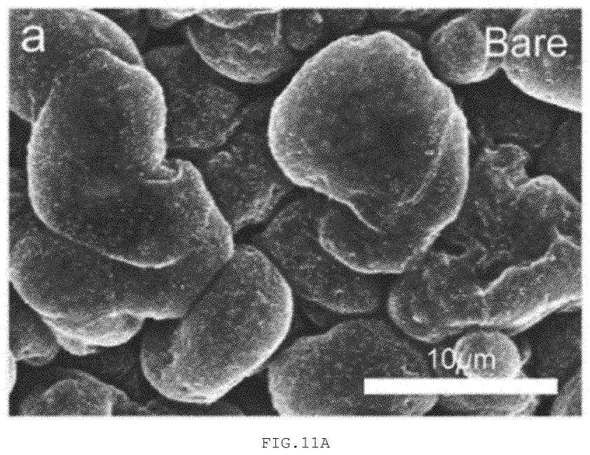

A lithium symmetric cell (bare) not configured with an interphase layer, a lithium symmetric cell (CN-PAA) with an interphase layer made of CN-PAA, and a lithium symmetric cell (PCN30-PAA) with an interphase layer made of PCN30-PAA were driven under a condition of 2 mA/cm² and 1 mAh/cm². Here, the thickness of lithium was about 40 μm, and an electrolyte prepared by adding 0.7M LiNO₃ to 1M LiTFSI DOL/DME was used. The results are shown in FIG. 10. Referring to FIG. 10, cell failure was observed in about 180 hours for the lithium symmetric cell (bare), and about 200 hours for the lithium symmetric cell (CN-PAA). On the other hand, the lithium symmetric cell (PCN-PAA) was stably driven for more than 400 hours.

### EXPERIMENTAL EXAMPLE 5—LITHIUM MORPHOLOGY ANALYSIS AFTER Lithium Symmetric Cell Test

A lithium symmetric cell (bare) not configured with an interphase layer, a lithium symmetric cell (CN-PAA) with an interphase layer made of CN-PAA, and a lithium symmetric cell (PCN15-PAA) with an interphase layer made of PCN15-PAA, a lithium symmetric cell (PCN30-PAA) with an interphase layer made of PCN30-PAA, and a lithium symmetric cell (PCN45-PAA) with an interphase layer made of PCN45-PAA were charged and discharged for 10 cycles under a condition of 2 mA/cm² and 1 mAh/cm², and then electrodeposition morphology of lithium was observed for each lithium symmetric cell.

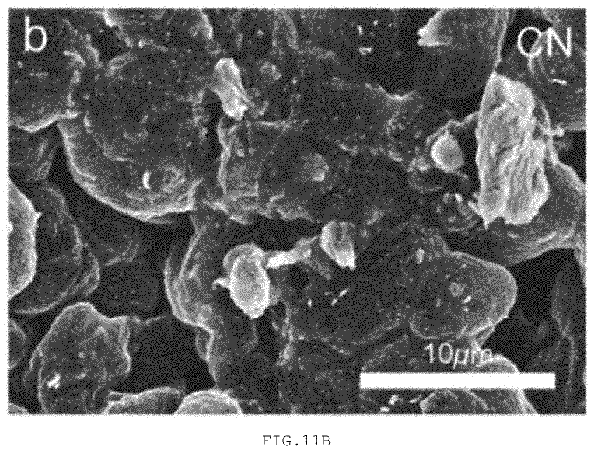

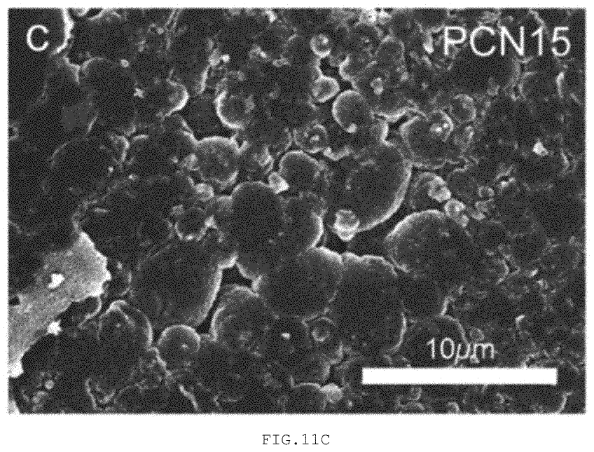

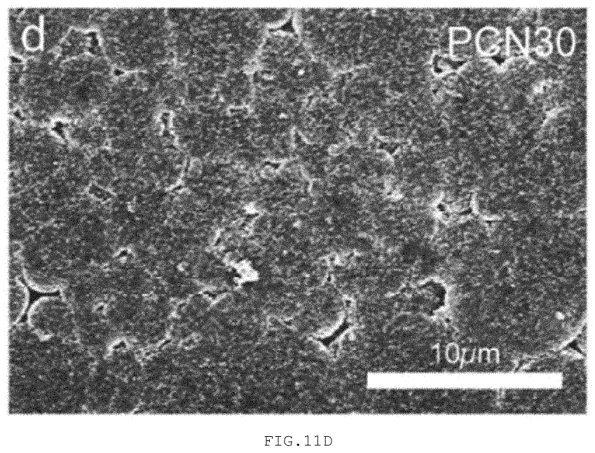

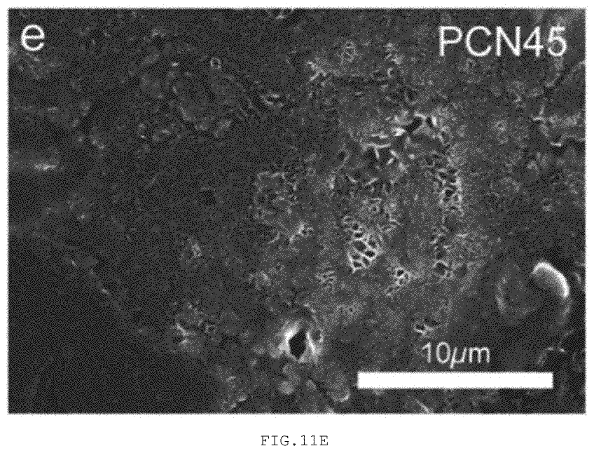

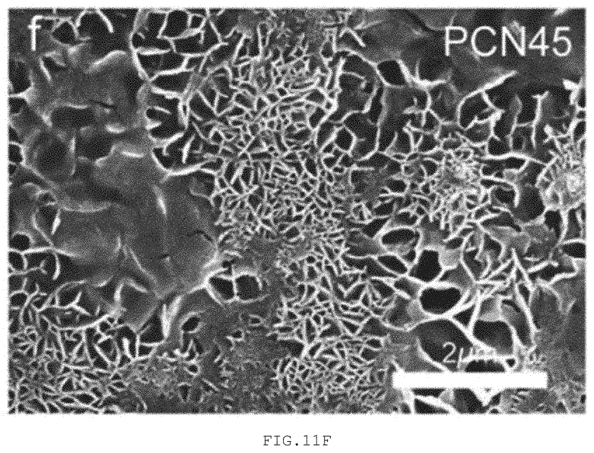

FIG. 11A illustrates a result of SEM analysis of a lithium surface of the lithium symmetric cell (bare); FIG. 11B illustrates a result of SEM analysis of a lithium surface of the lithium symmetric cell (CN-PAA); FIG. 11C illustrates a result of SEM analysis of a lithium surface of the lithium symmetric cell (PCN15-PAA); and FIG. 11D illustrates a result of SEM analysis of a lithium surface of the lithium symmetric cell (PCN30-PAA). FIGS. 11E and 11F illustrate the results of SEM analysis of a lithium surface of the lithium symmetric cell (PCN45-PAA) in different scales. Referring to FIGS. 11A to 11F, unlike the lithium symmetric cell (bare) where lithium grew in a noodle-like morphology, a more planar form of lithium morphology was observed as the amount of phosphorus doping increased. However, as the lithium symmetric cell (PCN45-PAA) had an excessive amount of phosphorus doping, a sharp lithium morphology was observed.

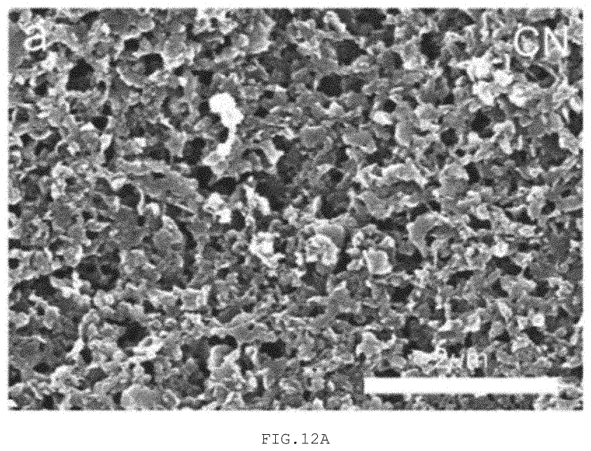

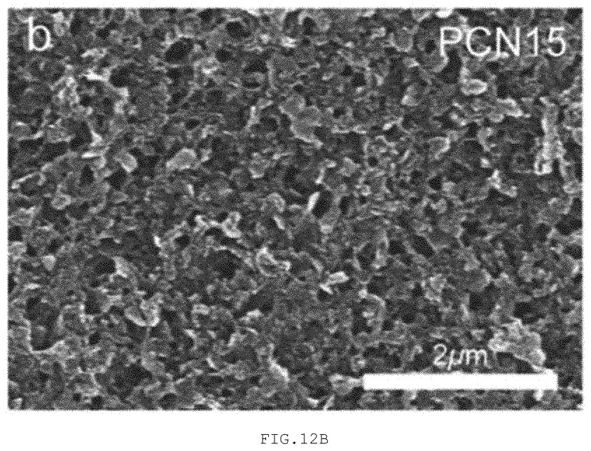

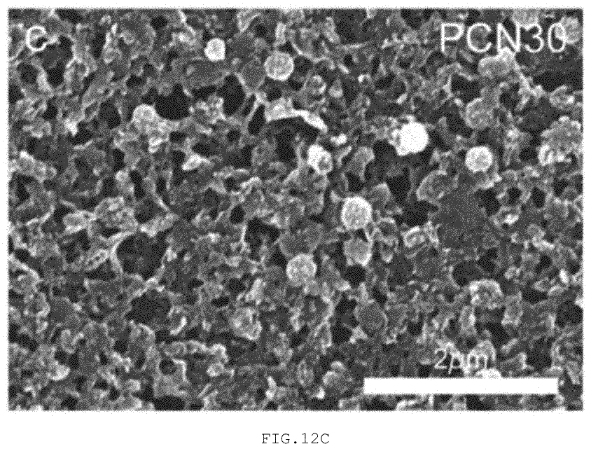

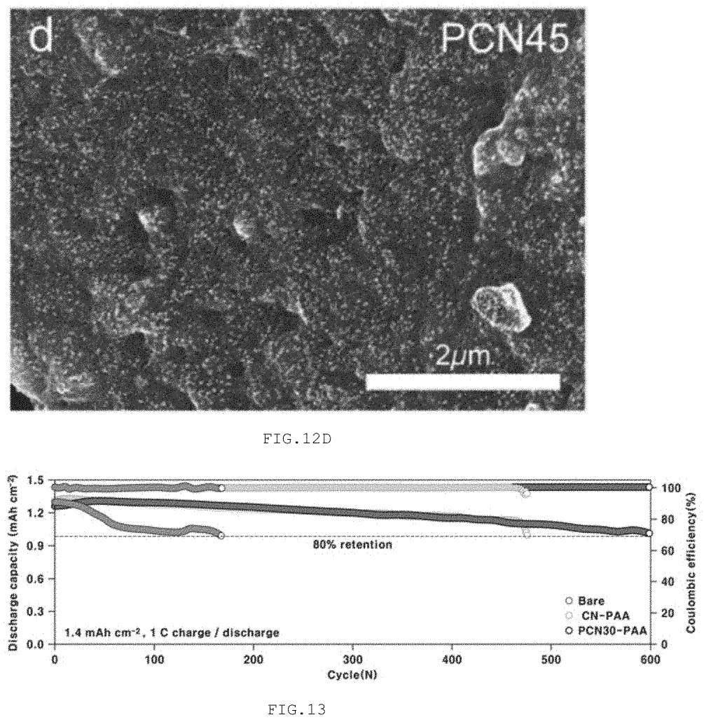

FIG. 12A illustrates a result of SEM analysis of a surface of an interphase layer of the lithium symmetric cell (CN-PAA); FIG. 12B illustrates a result of SEM analysis of a surface of an interphase layer of the lithium symmetric cell (PCN15-PAA); FIG. 12C illustrates a result of SEM analysis of a surface of an interphase layer of the lithium symmetric cell (PCN30-PAA); and FIG. 12D illustrates a result of SEM analysis of a surface of an interphase layer of the lithium symmetric cell (PCN45-PAA). In FIGS. 12A to 12D, a sharp shape lithium morphology of the lithium symmetric cell (PCN45-PAA) was observed, which is because only the interphase layer of the lithium symmetric cell (PCN45-PAA) lost a nanopore structure and was densified, resulting in blockage of conduction paths of lithium ions, and causing overvoltage.

### Experimental Example 6—Full Cell Test

A full cell (bare) not configured with an interphase layer, a full cell (CN-PAA) with an interphase layer made of CN-PAA, and a full cell (PCN30-PAA) with an interphase layer made of PCN30-PAA were driven under a condition of a current density of 1.4 mA/cm2 and voltage range of 2.5V to 4V. Here, the thickness of lithium was about 40 μm, and an electrolyte prepared by adding 0.7M LiNO₃ to 1M LiTFSI DOL/DME was used. The results are shown in FIG. 13. It was observed in FIG. 13 that the full cell (bare) had a lifespan of 170 cycles, the full cell (CN-PAA) had 475 cycles, and the full cell (PCN30-PAA) had 600 cycles on the basis of a capacity retention rate of 80%. In addition, the average coulomb efficiency was 99.45% for full cell (bare), 99.54% for the full cell (CN-PAA), and 99.82% for the full cell (PCN30-PAA).

Although the embodiments of the present disclosure have been disclosed for illustrative purposes, those skilled in the art should appreciate that various modifications, additions, and substitutions are possible, without departing from the scope and spirit of the present disclosure as provided in the accompanying claims. For example, a proper result may be achieved even if the techniques described above are implemented in an order different from that for the described method, and/or described constituents are coupled to or combined with each other in a form different from that for the described method or replaced by other constituents or equivalents. It should be understood, however, that there is no intent to limit the present disclosure to the embodiments described, rather, the present disclosure is to cover all modifications, equivalents, and alternatives falling within the spirit and scope of the present disclosure as defined by the claims.

What is claimed:

1. An anode for a lithium rechargeable battery, the anode comprising:
a lithium metal layer; and
an interphase layer provided on the lithium metal layer,
wherein the interphase layer includes phosphorus-doped graphitic carbon nitride.

2. The anode of claim 1, wherein the interphase layer is 10 nm to 5 μm thick.

3. The anode of claim 1, wherein the phosphorus-doped graphitic carbon nitride has a peak intensity ratio I₀₀₂/I₁₀₀ in a range of 7 to 8, wherein the peak intensity ratio I₀₀₂/I₁₀₀ is a ratio of a peak for a crystal plane (002) to a peak for a crystal plane (100) obtained in an X-ray diffraction (XRD) spectrum.

4. The anode of claim 1, wherein the phosphorus-doped graphitic carbon nitride exhibits P═N peak and P—N peak in P₂ₚ X-ray photoelectron spectroscopy (XPS).

5. The anode of claim 1, wherein the phosphorus-doped graphitic carbon has a concentration of phosphorus (P) in a range of 1 at. % to 2 at. %.

6. The anode of claim 1, wherein the interphase layer comprises at least one binder selected from the group consisting of polyacrylic acid (PAA), polyvinylidene fluoride (PVDF), poly(vinylidene fluoride-co-hexafluoropropylene) (PVDF-HFP), and combinations thereof.

7. The anode of claim 6, wherein a mass ratio of the phosphorus-doped graphitic carbon nitride and the at least one binder is 9:1 to 5:5.

8. A lithium rechargeable battery comprising:
a cathode;
an anode having a lithium metal layer and an interphase layer provided on the lithium metal layer, wherein the interphase layer comprises phosphorus-doped graphitic carbon nitride;
a separator disposed between the cathode and the anode; and
an electrolyte with which the separator is impregnated,
wherein the interphase layer is disposed between the separator and the anode.

9. A method of manufacturing a lithium rechargeable battery, the method comprising:
preparing a starting material including a carbon nitride precursor compound and a phosphorus precursor compound;
reacting the starting material to prepare phosphorus-doped graphite carbon nitride;
preparing a solution containing the phosphorus-doped graphitic carbon nitride and a binder;
applying the solution to a first surface of a separator to form an interphase layer;
configuring an electrode assembly in which the first surface of the separator where the interphase layer is formed faces a lithium metal layer serving as an anode and a second surface of the separator faces a cathode; and
injecting an electrolyte into the electrode assembly.

10. The method of claim 9, wherein the starting material comprises 70 wt. % to 85 wt. % of the carbon nitride precursor compound and 15 wt. % to 30 wt. % of the phosphorus precursor compound.

11. The method of claim 9, wherein the carbon nitride precursor compound comprises at least one compound selected from the group consisting of melamine, dicyanamide, urea, and a combination thereof.

12. The method of claim 9, wherein the phosphorus precursor compound comprises at least compound one selected from the group consisting of hexachlorotriphosphazene, aminoethylphosphonic acid, phosphoric acid, and a combination thereof.

13. The method of claim 9, wherein the starting material is reacted at a temperature in a range of 400° C. to 700° C. for 2 to 6 hours in an inert atmosphere.

14. The method of claim 9, wherein the binder comprises at least one compound selected from the group consisting of polyacrylic acid (PAA), polyvinylidene fluoride (PVDF), poly(vinylidene fluoride-co-hexafluoropropylene) (PVDF-HFP), and combinations thereof.

15. The method of claim 9, wherein a mass ratio of the phosphorus-doped graphitic carbon nitride and the binder is in a range of 9:1 to 5:5.

16. The method of claim 9, wherein the interphase layer is formed by applying the solution to the first surface of the separator and applying a vacuum pressure to the second surface of the separator to vacuum-filter the solution.

17. The method of claim 9, wherein the interphase layer is 10 nm to 5 μm thick.
